(19) United States
(12) Patent Application Publication
(10) Pub. No.: US 2016/0172807 A1
(43) Pub. Date: Jun. 16, 2016

(54) A SHELF POWER DISTRIBUTION APPARATUS

(71) Applicant: Gary James CLARK-WARD, Bury St Edmunds (GB)

(72) Inventor: Gary James Clark-Ward, Bury St Edmunds (GB)

(21) Appl. No.: 14/908,957

(22) PCT Filed: Jul. 29, 2014
(86) PCT No.: PCT/GB2014/052320

§ 371 Date: Jan. 29, 2016

(30) Foreign Application Priority Data
Aug. 1, 2013 (GB) 1313781.5

(51) Int. Cl. H01R 25/14; H01R 13/717; A47B 96/02; H01R 13/62

(52) U.S. Cl. CPC H01R 25/145; H01R 13/6205; H01R 13/7175; A47B 96/02

(57) ABSTRACT

A shelf power distribution apparatus comprising a track element that further comprises: a first electrical conductor and a first magnet, wherein the first magnet facilitates the attachment of the track element to a shelf; a first cover element that further comprises a second magnet; and wherein the second magnet facilitates the attachment of the cover to the track element.

### CROSS-REFERENCE TO RELATED APPLICATIONS

This application is a national phase entry under 35 U.S.C. §371 of International Patent Application PCT/GB2014/052320, filed Jul. 29, 2014, designating the United States of America and published in English as International Patent Publication WO 2015/015187 A1 on Feb. 5, 2015, which claims the benefit under Article 8 of the Patent Cooperation Treaty and under 35 U.S.C. §119(e) to United Kingdom Patent Application Serial No. 1313781.5, filed Aug. 1, 2013, the disclosure of each of which is hereby incorporated herein in its entirety by this reference.

### TECHNICAL FIELD

The disclosure relates to a shelf power distribution apparatus and, in particular, to a power distribution apparatus for commercial shelving units.

### BACKGROUND

Known methods of distributing power about a shelf and/or shelf unit require permanent fixings for securing electrical wires and any associated devices onto a shelf or within a shelf unit. These methods have the disadvantage of requiring an awkward and time-consuming operation of drilling holes and/or cutting access, which are required for the anchoring and routing of the cables and associated devices about the shelf and/or the shelf unit.

Another disadvantage of these known methods is that routed wires can be crushed on the assembly of the shelf/shelf unit, or when items are placed upon the shelf/shelf unit. Furthermore, if the cables and electrical devices are not adequately secured, they become susceptible to being caught and becoming damaged.

Known methods of power distribution employ the use of cabling enclosures, such as mini conduit or mini trunking, both of which require damaging the surface of the shelf/shelf unit through the use of permanent fixings, which are time consuming and very awkward to fit in a confined space.

When decommissioning the shelf/shelf unit, it is unlikely that the dismantling of known power distribution systems will render it or the shelf/shelf unit for subsequent reuse.

It is an objective of the claimed invention to overcome these disadvantages.

### BRIEF SUMMARY

In a first broad independent aspect, the disclosure provides a shelf power distribution apparatus comprising: a track element further comprising a first electrical conductor and a first magnet, wherein the first magnet facilitates the attachment of the track element to a shelf; a first cover element that further comprises a second magnet, wherein the second magnet facilitates the attachment of the cover to the track element.

This configuration provides a power distribution apparatus for a shelf, which does not require any permanent fixings to hold the conductor in place. For example, no screws or clamps will be required, along with any associated drilling or hole cutting, therefore, ensuring the apparatus is inexpensive and efficient to install to either a new or existing shelf or shelves.

Furthermore, this configuration provides a cover that both protects and insulates the conductor(s) from any unintended contact from the shelf and/or object placed on the shelf. Again, the cover does not require any permanent fixings to hold it in place.

Preferably, the first conductor is a flat copper conductor.

This enables the installation of the conductor onto a shelf, whereby the conductor minimizes its protrusion from the shelf, therefore, making it easier to install without interfering with the shelf itself, especially where space is limited.

Preferably, a shelf power distribution apparatus further comprises a second electrical conductor arranged adjacent to the first conductor.

This enables a compact electrical circuit to be routed about shelf; for example, the routing of an electrical power supply circuit that is comprised of a positive voltage (+V) conductor and an associated negative voltage (−V).

Preferably, the first conductor and/or second conductor is arranged in a linear configuration.

This enables the most efficient installation of the conductor(s) to the shelf, thereby keeping manufacturing costs to a minimum as no complicated routing of the conductor(s) is required. Furthermore, this configuration provides the most efficient method of routing the conductor(s) about the shelf(s).

Preferably, the first cover further comprises a third electrical conductor that cooperates with the first conductor.

This configuration provides an electrical connection that connects multiple track elements together. The connection is provided by the third conductor, which bridges the conductors of two abutting track elements together.

Preferably, the first cover further comprises a third magnet, whereby the second magnet is arranged at a first edge of the cover and the third magnet is arranged at a second edge of the cover and the third conductor is arranged between the second and third magnets; the first, second and third magnets are of the same thickness and the cover is a flexible element.

In this configuration, all of the magnets are of the same height; therefore, when the cover is located over the first electrical conductor, the height of the first electrical conductor and the height of the cooperating third conductor of the cover lifts the center of the cover. The outer second and third magnets pull the cover down along its edges, therefore, causing the cover to flex downward about the cooperating conductors. The flexing of the cover forces the cooperating conductors together, mainly along their outer edges, to ensure a good electrical contact is provided between them.

Preferably, a shelf power distribution apparatus further comprises a second cover element that further comprises a fourth magnet and a fourth electrical conductor, wherein the first magnet further comprises a separating element between the first conductor and the second conductor.

This configuration enables the individual conductors of the track element to be covered/exposed, or bridged, independently from any other conductors of the rack element.

Preferably, a shelf power distribution apparatus further comprises an attachable electrical contact element that comprises a fourth magnet and a fifth magnet, which, in use, facilitates the attachment of the electrical contact element to the track element.

This configuration provides an attachable electrical contact element that does not require any permanent fixings to hold it in place.

Preferably, the electrical contact element further comprises a fourth electrical conductor that cooperates with the first conductor, which, in use, provides electrical power from the first conductor.

This configuration enables the electrical contact element to pick up electrical power from the track element and is subsequently used to power an attached electrically powered device.

Preferably, the electrical contact element further comprises a lead to an electrically powered device.

This enables the routing of the picked up electrical power from the electrical contact means to attach to the electrically powered device.

Preferably, the lead further comprises a coupling means for disconnecting the electrically powered device.

This enables the removal of the electrically powered device from the electrical contact means.

Preferably, the electrical contact element further comprises a deformable pad under the fourth electrical conductor, which, in use, forces the fourth electrical conductor of the electrical contact element onto an electrical contact of the track element.

This configuration provides a good electrical connection between the conductor of the electrical contact means and the conductor of the track element.

Preferably, the electrically powered device further comprises a sixth magnet.

This configuration provides an electrically powered device that does not require any permanent fixings to hold it in place.

Preferably, the electrically powered device is a Light-Emitting Diode (LED) illumination device.

This configuration provides a low-power illumination device that will illuminate a shelf.

Preferably, the electrically powered device is a shelf-marking device.

This configuration provides a product position marker, which illuminates and identifies a product placement on a shelf.

Preferably, the track element, the first cover element and the second cover element are manually shearable.

This configuration enables a user to cut the track element, first cover element and second cover element by hand; for example, the user could use a pair of scissors to adjust their length.

Preferably, this disclosure provides a shelf or furniture item comprising a shelf power distribution apparatus in accordance with any of the above features.

This configuration provides a shelf or furniture item that is made or supplied with the shelf powered distribution apparatus.

In a second broad independent aspect, the disclosure provides an LED illumination device comprising an electrical contact element that further comprises a first magnet and a second magnet and is thereby attachable to a track element; and an electrical conductor, which in use, cooperates with an electrical conductor of a track element to provide electrical power.

This configuration provides an LED illumination device that is made or supplied for use with, or as a spare component for, a shelf power distribution apparatus.

In a third broad independent aspect, the disclosure provides a shelf-marking device comprising an electrical contact element that further comprises a first magnet and a second magnet and is thereby attachable to a track element; and an electrical conductor, which, in use, cooperates with an electrical conductor of a track element in providing electrical power.

This configuration provides a shelf-marking device that is made or supplied for use with, or as a spare component for, a shelf power distribution apparatus.

In a fourth broad independent aspect, the disclosure provides a track cover device comprising a first magnet and a second magnet and is thereby attachable to a track element and an electrical conductor, which, in use, co-operates with a first electrical conductor of a first track element and a first electrical conductor of a second track element and connects electrical power from the first track element to the second track element.

This configuration provides a track cover device that is made or supplied for use with, or as a spare component for, a shelf power distribution apparatus.

In another broad aspect, the disclosure provides a shelf power distribution apparatus comprising: a track element further comprising a first electrical conductor and a first magnet, wherein the first magnet facilitates the attachment of the track element to a shelf.

This configuration provides a power distribution apparatus for a shelf that does not require any permanent fixings to hold the conductor in place; for example, no screws or clamps will be required, along with any associated drilling or hole cutting, therefore, ensuring the apparatus is inexpensive and efficient to install to either a new or existing shelf or shelves.

Preferably, a shelf power distribution apparatus further comprises a first cover element that further comprises a second magnet member, wherein the second magnet facilitates the attachment of the cover to the track element.

This configuration provides a cover that both protects and insulates the conductor(s) from any unintended contact from the shelf and/or object placed on the shelf Again, the cover does not require any permanent fixings to hold it in place.

Preferably, the electrical contact element further comprises a deformable pad under the fourth electrical conductor, which, in use, forces the fourth electrical conductor of the electrical contact element onto the first electrical contact of the track element.

This configuration provides a good electrical connection between the conductor of the electrical contact means and the conductor of the track element.

### BRIEF DESCRIPTION OF THE DRAWINGS

FIG. 1, panel (a), shows an exploded perspective view of the power distribution apparatus.

FIG. 1, panel (b), shows a perspective view of the assembled power distribution apparatus.

FIG. 2, panel (a), shows a perspective view of the underside of a cover element, which may interface with a rear track element.

FIG. 2, panel (b), shows an end view of the cover element mounted in a front to rear configuration.

FIG. 3 shows an end view of the cover element mounted in a “flexed” front to rear configuration.

FIG. 4, panel (a), shows an upper perspective view of an electrical pick up element, which may interface with a rear track element.

FIG. 4, panel (b), shows a lower perspective view of an electrical pick up element, which may interface with a rear track element.

FIG. 5 shows a close-up perspective view of an electrical conductor arranged on the underside of an electrical pick up element.

FIG. 6 shows a lower exploded perspective view of an alternative embodiment of a rear track and two associated tracks and an end perspective view of an alternative embodiment of the disclosure that incorporates two cover elements.

### DETAILED DESCRIPTION

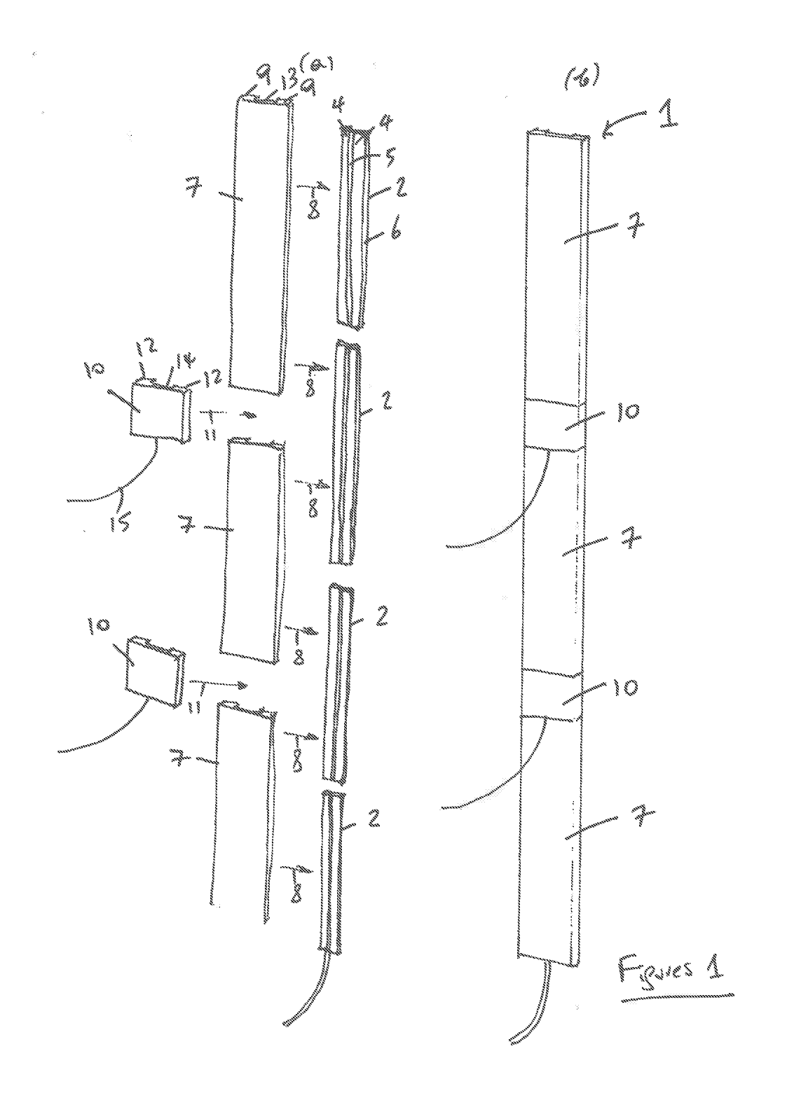

FIG. 1, panel (a), shows an exploded perspective view of a shelf power distribution apparatus, which is generally indicated by 1. Four track elements 2 are vertically aligned end to end, and the bottom track element 2 further incorporates an electrical power lead 3. Each track element 2 incorporates two electrical conductors 4. Each electrical conductor 4 is a flat, linear, elongated copper conductor. The two copper conductors 4 are arranged adjacent to each other on the magnetic body member 6 of each track element 2, along with a separating region 5 located between them. The magnetic body member 6 is typically a magnetic strip formed from a ferrite-based material. Each track element 2 is rectangular in shape, which accommodates a footprint that is the same size as the two adjacent electrical conductors 4.

Three rectangular cover elements 7 for covering the four track elements 2 are indicated by arrows 8. Each cover element 7 further incorporates two elongated magnetic strips 9, which are arranged at opposing side edges, thereby forming a central recess 13 between them. The central channel 13 provides a close-fitting arrangement for accepting the co-operating track elements 2.

Two electrical contact elements 10 (also known as power pick-up points), for splitting of electrical power from track elements 2 are indicated by arrows 11 and are intended to be located between two adjacent ends of two neighboring cover elements. Each electrical contact element 10 further incorporates two magnets 12, which are arranged at opposing side edges, thereby forming a central recess 14 between them. The central channel 14 provides close-fitting arrangement for accepting the co-operating track elements 2. Each electrical contact element 10 further incorporates an electrical lead 15, which is also connected to an electrically operated device (not shown). The electrically operated device is powered by the electrical energy picked up by the electrical contact element 10 from the track element 2.

FIG. 1, panel (b), shows a perspective view of the electrical power distribution apparatus 1 assembled together, whereby the three cover elements 7 are located on the track elements (not shown). Between the adjacent ends of each cover element 7 is an electrical contact assembly 10 that is also located on the track element 2.

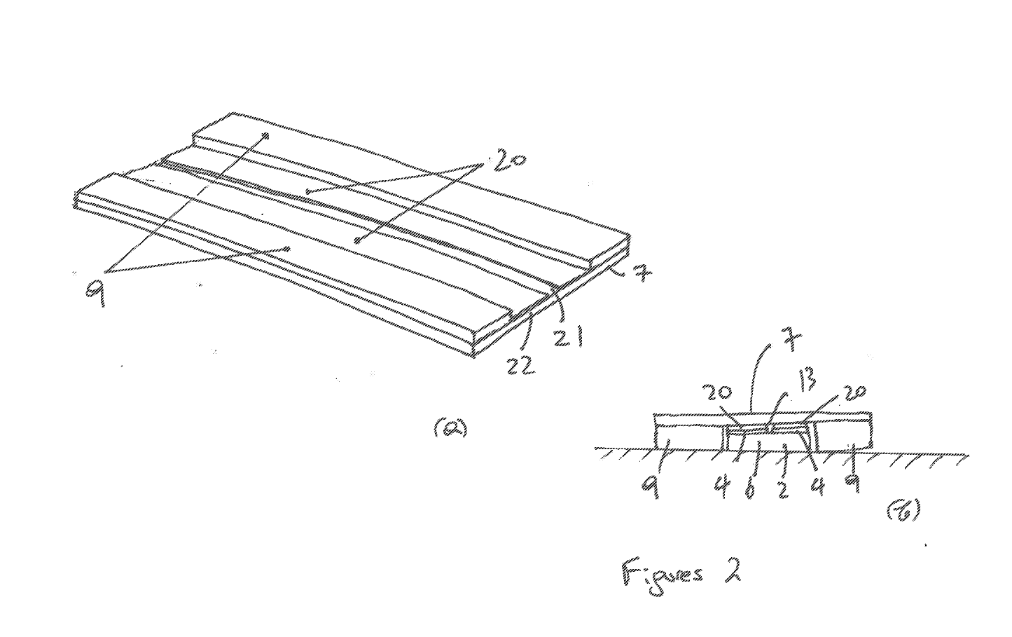

FIG. 2, panel (a), shows a perspective view of the underside of the cover element 7, which has the two elongate magnetic strips 9 that are arranged on two elongated side edges, whereby two magnetic strips are also opposed to each other. The magnetic strips 9 are formed from a ferrite-based material and are substantially linear, rectangular and flat in shape.

The magnetic strips 9 extend along the length of the cover, whereby they abut the top and bottom edges, as well as abutting the side edge.

The cover element 7 further incorporates two electrical conductors 20, both of which extend along the length of the cover element 7 and abut both at the top and bottom edges of the cover element 7. Each electrical conductor 20 is also adjacent to the inside edge of a magnet strip 9. Each electrical conductor 20 is substantially a flat, linear, elongated copper conductor that is formed from a copper conductor. Therefore, each electrical conductor is in the form of a copper foil. The two electrical conductors 20 are positioned adjacent to each other, and are separated by a linear gap 21 that extends between the top and bottom edges of the cover element 7. The cover element 7 further incorporates a substantially flat rectangular cap portion 22 upon which the magnets 9 and electrical conductors 20 are arranged. The cap portion 22 is typically formed from a flexible plastic material.

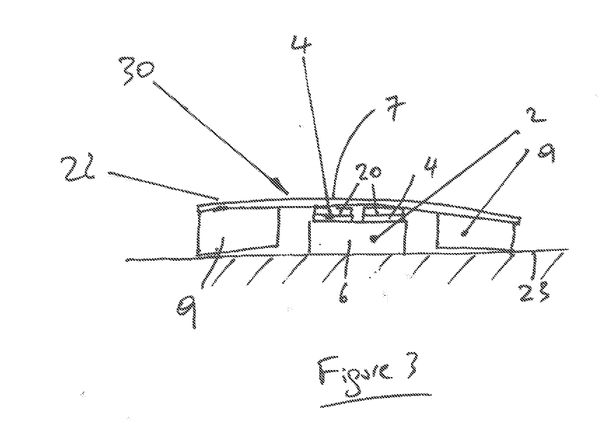

FIG. 2, panel (b), shows an end view of the cover element 7 located upon a track element 2, whereby the track element 2 is accommodated in the rear of the cover element 7 in a front-mounted rear configuration. The magnetic strips 9 of the cover element 7 attach the cover element 7 to a shelf or a furniture item's surface 23 (see FIG. 3). The magnet body member 6 of the track element 2 is also attached to the shelf or furniture item's surface 23. The close fit of the track element 2 within the cooperating central channel 13 of the cover element 7 enables the electrical conductors 4 to abut and cooperate with their electrical conductors 20 of the cover element 7. The magnetic strips 9 of the cover element 7 and the magnetic body member 6 of the track element 2 enables their fixing onto a shelf or furniture item's surface without the use of any permanent fixings or screws that require the drilling of holes, etc.

FIG. 3 shows an end view of the cover element 7 whereby the magnetic body member 6 of the track element 2 is the same thickness as the magnetic strips 9 of the cover element 7 and provide support at the same height from the surface of the shelf or furniture item's surface 23. The cap portion 22 of the cover element 7 is separated from the top surface of the magnet body member 6 of the track element 2 by the two electrical conductors 20 of the cover element 7, which are abutting the electrical conductors 4 of the track element 2. Therefore, in use, the magnetic strips 9 of the cover element 7 pull down the cap portion 22 of the cover element 7, which causes the flexing of the cap portion 22 at the point indicated by arrow 30. This, in turn, forces the electrical conductors of the cover element 7 onto and together with the electrical conductors 4 of the track element 2, in particular, at the outer edges, which ensure a good electrical contact and power communication between the track element 2 and the cover element 7.

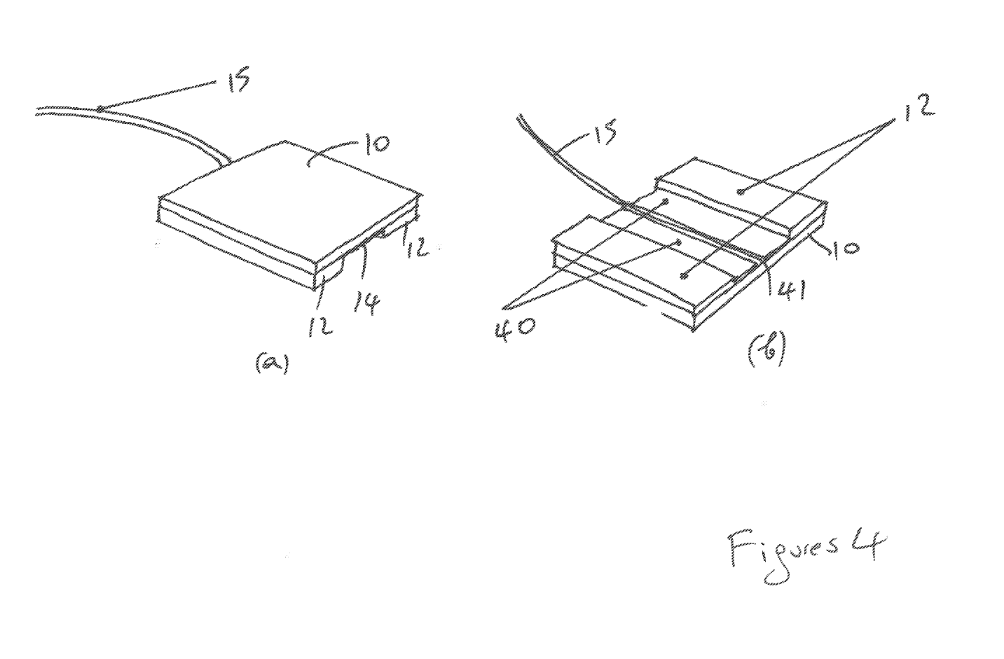

FIG. 4, panel (a), shows an upper perspective view of the electrical contact element 10, along with an electrical lead 15 that is also connected to an electrically powered device (not shown). The magnetic strips 12 are arranged along two opposed side edges of the electrical contact element 10 and form a central channel 14 in which the track element 2 is located in use.

FIG. 4, panel (b), shows a perspective view of the bottom surface of the electrical contact element 10 whereby the magnetic strips 12 are arranged along two opposing side edges and extend along the length of the electrical contact element 10. The magnetic strips are typically formed from a ferrite-based material. Two electrical conductors 40 extend along the length of the electrical contact element 10. Each electrical conductor 40 is substantially a flat, linear, elongated copper conductor that is formed from a copper conductor and is typically in the form of copper foils. The electrical conductors 40 are located adjacent to each other, but are separated from each other by a separating region 41 that is adjacent to the inside edge of each electrical conductor 40. The overall shape of the electrical contact element 10 is substantially a square configuration. The electrical lead 15 further incorporates electrical conductors (not shown) that are attached to each of the electrical conductors 40 and facilitates the communication of electrical power from the electrical contact element 10 to the electrically powered device (not shown) attached to the other end of the electrical lead 15.

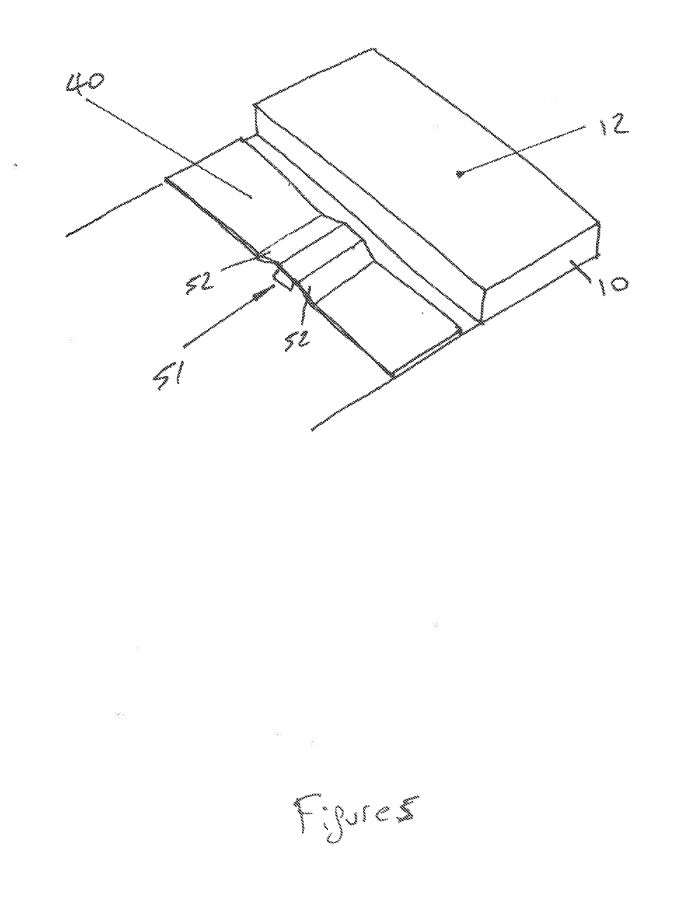

FIG. 5 shows a close-up perspective view of the underside of the electrical contact element 10. An electrical conductor 40 extends along the length of the electrical contact element 10 and further incorporates a pad 51, which extends under and along the width of the electrical conductor 40. The pad 51 lifts the electrical conductor 40, biasing it toward a cooperating conductor of the track element 2, therefore providing and ensuring good electrical contact between the two conductors. The electrical conductor 40 further incorporates two gradient portions 52 that raise the track from the under surface of the electrical contact element to the raised flat surface provided by the pad 51. The electrical conductor 40 is adjacent to a magnetic side strip 12 of the electrical contact element 10. The pad 51 provides a power pick-up function of the electrical contact element 10 and is typically formed from a portion of deformable material, such as foam rubber that is fitted under the electrical conductor 40 to ensure that it is “pressed” into contact position with a cooperating conductor of the track element 2.

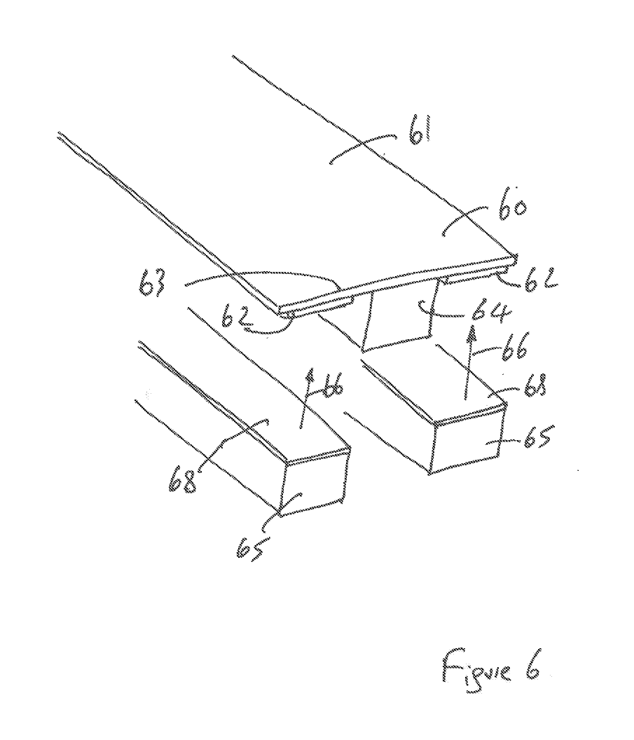

FIG. 6 shows a perspective view of the end of an alternative embodiment of the disclosure whereby a track element 60 further incorporates a body member that is an elongated magnetic strip 61. The track element 60 further incorporates two electrical conductor strips 62 located upon its upper surface 63. The two electrical conductor strips 62 are formed by elongate copper foils and are separated from each other via a separating block 64 that is adjacent to the inside edge of each conductor strip 62. The separating block 64 is typically formed from an electrically insulated material. Two elongate cover strips 65 cooperate with the recesses in which the electrical conductor strips 62 of the track element 60 reside and is indicated by arrows 66. Each cover strip 65 is formed from a magnetic material, which is typically a ferrite-based material. Each cover strip 65 further incorporates an electrical conductor 68, which extends along its length and cooperates with electrical conductor strip 62 of the track element 60. This enables the independent exposure of each electrical conductor of the track element 60.

In use, the shelf power distribution apparatus can be fitted to any shelf upon which the magnets of the track elements, the cover elements and the electrical contact element are able to cooperate with. This means that there are no permanent fixings required, therefore, eliminating the awkward handling or positioning of wires, or cable forming of a loom to distribute electrical power about the shelf or unit; whereby the cables are in risk of being damaged by the shelf or shelf unit itself or the objects placed upon it. Furthermore, the flat orientation of the track members and the cover provides a means of distributing power around the shelf and the shelf unit while providing the greatest workspace for placing objects on the shelf without the risk of the objects becoming caught up with any loose cabling.

The system can be arranged by manually placing the objects upon the shelf or shelf unit's surface. The system can also be cut to suitable size with either a pair of scissors, or shears, which makes it very easy to use without the requirement of any special tooling. When decommissioning the system, the whole power distribution apparatus can be just literally peeled off the surface of the shelf or the unit without leaving any damage or holes within the shelf or shelf unit's surface.

The cover element provides the means for bridging the power between multiple track elements via the electrical conductors incorporated within it. Therefore, no special coupling or tooling is required to join any track elements together.

The components of the power distribution apparatus are made from a plastic material and are designed to be inherently thin and flexible, which facilitates their placement within a shelf or shelf unit.

As mentioned above, the components of the power distribution apparatus are formed from thin and flexible plastic materials, the magnetic strips typically formed from a ferrite material, and thin copper foils, all of which facilitate the easy cutting and resizing of each component by the user via pair of scissors or shears.

The power distribution apparatus is intended to supply a low voltage power supply about the shelf or furniture unit item, which can power any electrically powered device via the electrical contact elements that tap off the electrical supply to each electrical device. The power supply could be a low voltage DC power supply and could optionally incorporate a main voltage AC supply if required.

The typical power devices that will be powered by the distribution apparatus would be shelf illumination devices, such as LED lights, and product markers that are used to display the positioning of goods upon the shelves and their associated pricing; these markers would incorporate some kind of electrical display.

In an alternative embodiment of the electrical contact element, an electrical coupling is fitted within the electrical lead to enable the removal of the electrical device from the electrical contact element while it is located on a track element.

The power distribution apparatus provides the following advantages:
low voltage power transmission track system;
totally safe for any given environment;
innovative, low power, light weight;
rear track concealed by front track that acts as a protective cover;
power transmission is by overlapping the front and rear;
the rear sits inside the track;
a low-cost option;
adaptable and fits current shelving systems (as long as they are steel, or facilitate the use of magnets in some form);
modular system that has an infinite number of permutations;
primarily for shelving;
can easily be cut to size to suit, avoiding modifications to shelving systems;
low profile;
front cover can be colored to match the back color of the shelves, or shelf units;
could be used to run a variety of items such as shelf markers;
can power other 12 volt equipment on a shelf;
retrospective installation of the power distribution apparatus to an existing shelf or furniture item;
can be used to power any 12-volt applications; and
no permanent fixing such as magnets hold the track and other components in place on the shelf or shelf unit.

In an alternative embodiment of the disclosure, the power distribution apparatus could be provided in a kit consisting of:
a magnetic track element that comprises an electrical conductor;
a magnetic cover element that covers a magnetic track element; and
an electrical contact element that picks up electrical power from a magnetic track element.

The electrically powered devices connected to the electrical contacts elements could also be provided, either attached or unattached, via a coupling within the electrical lead from the electrical contact assembly

1. A shelf power distribution apparatus comprising:
a track element further comprising a first electrical conductor arranged on a surface of said track element, whereby said first electrical conductor extends along the length of said track element;
a first cover element comprising a first magnet, wherein said first magnet enables the attachment of said first cover element to said track element; and
wherein said track element that-further comprises a second magnet,
wherein said second magnet facilitates the attachment of said track element to a shelf, and said first cover element is adapted to house said track element and further comprises a second electrical conductor that extends along the length of said first cover element and cooperates with said first electrical conductor.

2. An apparatus according to claim 1, wherein said first and second electrical conductors are flat copper conductors.

3. An apparatus according to claim 1, further comprising a third electrical conductor arranged adjacent to said first electrical conductor.

4. An apparatus according to claim 1, wherein said first and second electrical conductors are arranged in a linear configuration.

5. An apparatus according to claim 1, wherein said first magnet enables the attachment of said first cover element about said first electrical conductor.

6. An apparatus according to claim 1, wherein said first cover element further comprises a third magnet, whereby said first magnet is arranged at a first edge of said first cover element and said third magnet is arranged at a second edge of said first cover element and said third second electrical conductor is arranged between said second and third magnets; said first, second and third magnets are of the same thickness and said first cover element is a flexible element.

7. An apparatus according to claim 6, further comprising a second cover element that further comprises a fourth magnet and a fourth electrical conductor and wherein said second magnet further comprises a separating element between said first conductor and said third electrical conductor.

8. An apparatus according to claim 1, further comprising an attachable electrical contact element that comprises a magnet and a sixth magnet, which enables the attachment of said electrical contact element to said track element.

9. An apparatus according to claim 8, wherein said electrical contact element further comprises a fifth electrical conductor that cooperates with said first electrical conductor, which enables the communication of electrical power from said electrical contact element to an electrically powered device.

10. An apparatus according to claim 8, wherein said electrical contact element further comprises a lead to an electrically powered device.

11. An apparatus according to claim 10, wherein said lead further comprises a coupling means for disconnecting said electrically powered device.

12. An apparatus according to claim 9, wherein said electrical contact element further comprises a deformable pad under said fifth electrical conductor, which in use forces said fifth electrical conductor of said electrical contact element onto an electrical contact of said track element.

13. An apparatus according to claim 8, wherein electrically powered device further comprises a seventh magnet.

14. An apparatus according to claim 9, wherein said electrically powered device is a Light-Emitting Diode (LED) illumination device.

15. An apparatus according to claim 9, wherein said electrically powered device is a shelf-marking device.

16. An apparatus according to claim 7, wherein said track element, said first cover element and said second cover element are manually shearable.

17. A shelf or furniture item comprising a shelf power distribution apparatus in accordance with claim 1.

18-24. (canceled)
